(19) United States
(12) Patent Application Publication
(10) Pub. No.: US 2022/0055798 A1
(43) Pub. Date: Feb. 24, 2022

(54) MOUNTING APPARATUS FOR MOBILE CONSUMER ELECTRONIC DEVICES

(71) Applicants: Jeff Morris, Miami, FL (US); Rick Rozendaal, Costa Mesa, CA (US)

(72) Inventors: Jeff Morris, Miami, FL (US); Rick Rozendaal, Costa Mesa, CA (US)

(21) Appl. No.: 16/947,900

(22) Filed: Aug. 24, 2020

(51) Int. Cl. B65D 23/12; B32B 5/26; F16C 11/06; F16B 1/00

(52) U.S. Cl. CPC B65D 23/12; B32B 5/26; F16B 2001/0035; F16B 1/00; F16C 11/0695

(57) ABSTRACT

A mount for a mobile electronic device is configured to secure around a water bottle or similar structural support. The mount includes a magnetic ball sleeve that attaches around a water-bottle allowing the consumer to mount their phone magnetically to the mount. The invention allows one to increase the functionality of their existing tools and in so doing, eliminates the need to carry additional items to achieve the same level of functionality. The mount includes an elongate elastic sleeve with a slot at one end and cooperating fasteners at a second end. The sleeve is configured to cinch about the supporting structural element. A ball and socket are attached to the sleeve. The socket and a device plate are magnetically attracted. The device plate is attached to the mobile electronic device, such that the mobile electronic device may be removably attached to the mount.

### CROSS-REFERENCE TO RELATED APPLICATION

This application claims the benefit of priority of U.S. provisional application No. 62/874,840 filed Jul. 16, 2019, the contents of which are herein incorporated by reference.

### BACKGROUND OF THE INVENTION

The present invention relates to mobile consumer electronic devices, and more particularly to accessories for mounting mobile consumer electronic devices.

Individuals seek to derive utility from their consumer electronic devices, such as cellular phones, in a hands-free fashion but lack the tools to do so. Furthermore, having the electronic device in their hands while performing activities can cause safety or logistics problems. This can constrain both the activities that one can perform and limits the functionalities of the mobile electronic device.

While there are various mobile electronic device mounts, there are no mounting devices specifically designed to attach a consumer electronic device to a water bottle. For example, a water bottle makes for an idea way to transport water and provides a readily accessible platform for the user to view entertainment, film, talk etc. without the need to carry a separate mechanism to prop the electronic device up for viewing or listening. For example, a tripod serves very well as a standalone tripod but maybe not so well for a stand/phone holder such as for receiving and presenting GPS directions while driving.

As can be seen, there is a need for an improved mounting apparatus for a mobile electronic device.

### SUMMARY OF THE INVENTION

In one aspect of the present invention, a mount for a mobile electronic device is disclosed. The mount includes an elongate elastic sleeve having a first end, a second end and an intermediate portion disposed between the first end and the second end. A fastener is attached proximal to the second end of the elongate elastic sleeve. A cooperating fastener is attached to the intermediate portion proximal to the fastener. A slot is defined transversely and extends through the elongate elastic sleeve. The slot is dimensioned to receive the fastener and at least a portion of the elongate elastic sleeve between the fastener and the cooperating fastener. A ball mount is attached to the intermediate portion between the cooperating fastener and the slot. A socket is coupled to the ball mount. The socket is formed of one of a magnetically attractive or a magnetic material.

In some embodiments, a device plate is formed of one of a material complimentary to the one of the magnetically attractive or the magnetic material of the socket. An adhesive layer is provided on a device facing surface of the device plate.

In some embodiments, the elongate elastic sleeve includes a plurality of fabric layers. The plurality of fabric layers includes a surface laminate layer, a lining laminate layer; and a core layer disposed between the surface laminate layer and the lining laminate layer.

In some embodiments, a backing plate is attached to a front surface of the elongate elastic sleeve. A backing plate fastener couples the ball mount to the backing plate.

In other embodiments, a pocket is dimensioned to surround the backing plate and attach the backing plate to the front surface of the elongate elastic sleeve.

In other embodiments, the fastener and cooperating fastener are formed of a hook and a loop material.

In yet other embodiments, a reinforcement is defined about the slot. The reinforcement may be a stitch. The reinforcement may alternatively be a solid or a semi-solid grommet.

These and other features, aspects and advantages of the present invention will become better understood with reference to the following drawings, description and claims.

### BRIEF DESCRIPTION OF THE DRAWINGS

FIG. 1 is a front perspective view of a mounting apparatus for a mobile electronic device, shown in use.

FIG. 2 is a rear perspective view of the mount, illustrating the placement of a mobile electronic device onto base 34.

FIG. 3 is a perspective view of the mount in a flat position.

FIG. 4 is an exploded view of the mount.

FIG. 5 is a section view of the mount, taken along line 5-5 in FIG. 3.

FIG. 6 is a section view of the mount, taken along line 6-6 in FIG. 1, showing mobile electronic device 38 attached.

FIG. 7 is a section view of the mount, taken along line 7-7 in FIG. 6, illustrating the vertical movement of the mobile electronic device 38 and base 34.

FIG. 8 is a section view of the mount, illustrating the horizontal movement of the mobile electronic device 38 and base 34.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provides an apparatus and method for mounting a mobile consumer electronic device. The mobile consumer electronic device may be a cellular telephone, a video or audio player, a global positioning system, and the like. The mount is configured to secure the mobile electronic device to a water bottle or other tubular or frame member.

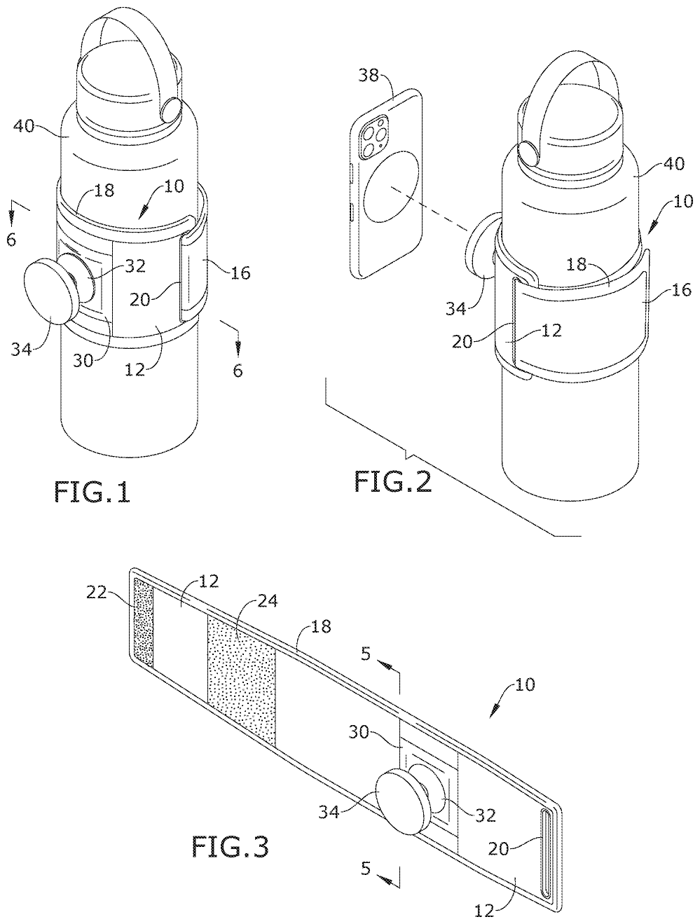

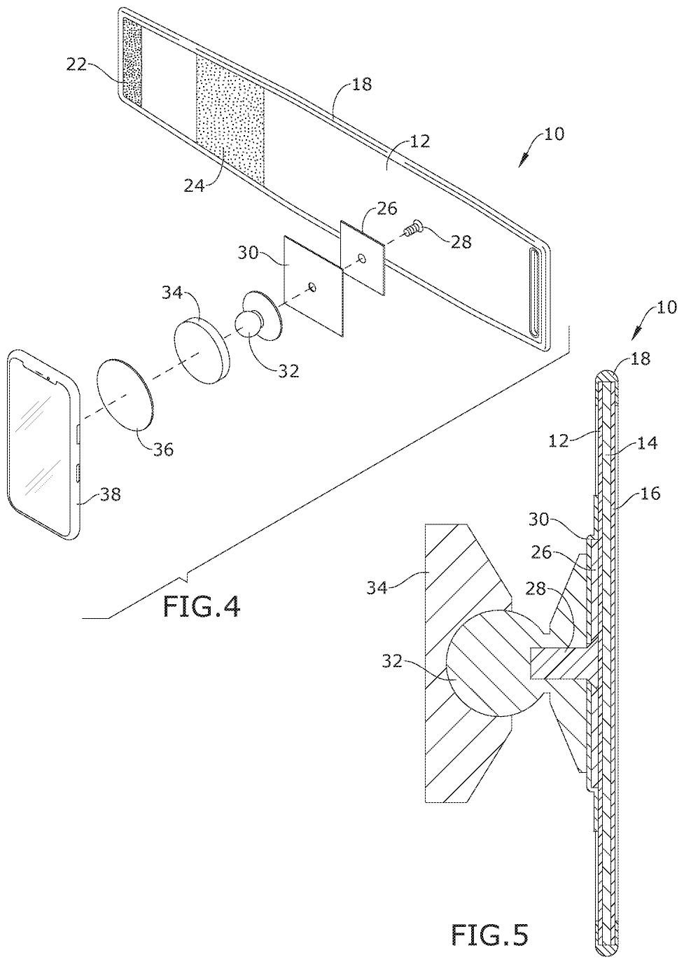

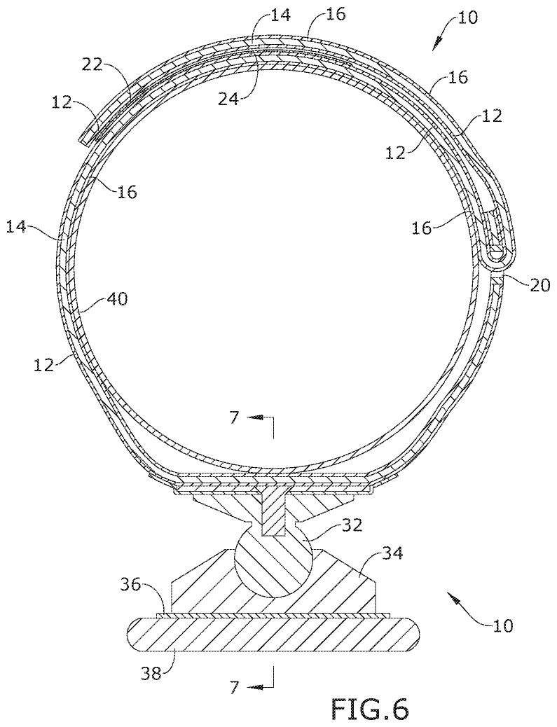

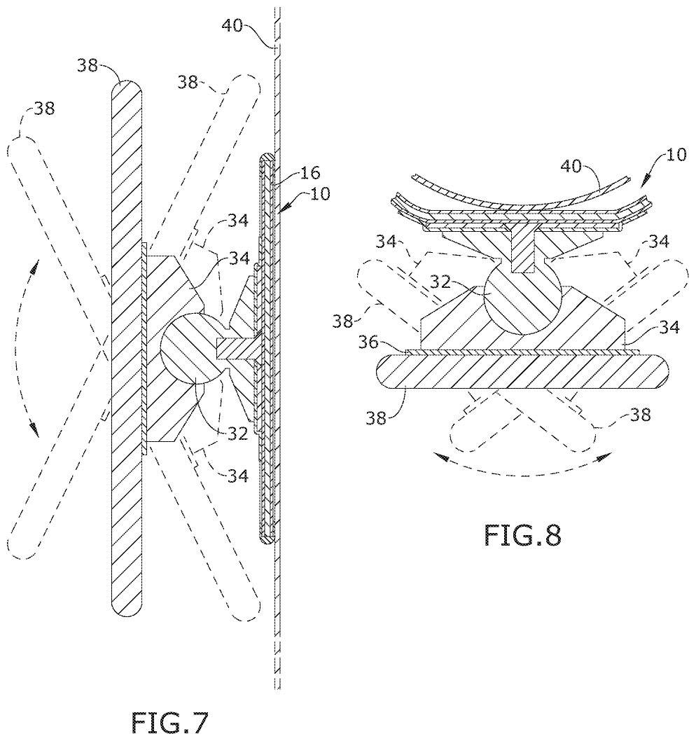

As seen in reference to the drawings of FIGS. 1-8, the mount 10 includes an elongate fabric sleeve having a first end, a second end, and an intermediate portion between the first end and the second end. The elongate fabric sleeve includes a plurality of layers. A surface laminate layer 12 is provided on a front face of the elongate sleeve. A core layer 14 is disposed between the surface laminate layer 12 and a lining laminate layer 16 provided on a rear face of the elongate sleeve. A piping 18 may be provided around a peripheral edge surface of the elongate sleeve to contain an edge of the surface laminate layer 12, the core layer 14, and the lining laminate layer 16.

A slot 20 is defined transversely through plurality of layers proximal to the first end of the elongate sleeve. The slot 20 may be reinforced by stitching. Alternatively, the slot 20 may be formed of a rigid or semi-rigid material surrounding a slot opening, such as a grommet construction, or the like. A fastener 22 is provided on the surface laminate layer 12 proximal to the second end of the elongate sleeve. A cooperating fastener 24 is provided on the surface laminate layer 12 at the intermediate portion of the elongate sleeve proximal to the fastener 22. The fastener 22 and the cooperating fastener 24 may be formed of a hook and loop material, a snap, or other suitable cooperating fastener configuration.

The mount 10 also includes a backing plate 26 attached to the elongate sleeve. A backing plate fastener 28, such as a pin, bolt, rivet, or screw extends through the backing plate 26 for attachment to a ball mount 32. In some embodiments, a pocket 30 may be provided to secure the backing plate 26 to the front face of the elongate sleeve. The pocket 30 may be secured via an adhesive or a stitch. The pocket 30 may surround the backing plate 26. The ball mount 32 is rotationally and pivotally coupled to a socket 34. The socket 34 may be formed of one of a magnet or a magnetically attractive material and is configured to magnetically couple to a device plate 36.

The device plate 36 is formed of one of a magnet or a magnetically attractive material and is provided to attach to a back surface of the mobile electronic device 38 via an adhesive, a double-sided adhesive tape, and the like. Magnetic attraction between the device 36 and the socket 34 removably couples the mobile electronic device 38 to the mount 10. When coupled to the mount 10, the mobile electronic device 38 may be rotationally and pivotally adjusted about the ball mount 32 and the socket 34.

In some embodiments, the mount 10 may be configured for attachment to a conventional drinking vessel 40, such as a water bottle, a thermos, and the like. In these embodiments, a longitudinal length of the elongate the elongate sleeve is dimensioned to encircle the drinking vessel 40 and permit the fastener 22 to be routed through the slot 20 and be secured to the cooperating fastener 24.

Preferably, the plurality of layers of the elongate sleeve are made of an elastically stretchable material, such that the elongate sleeve may be cinched about the drinking vessel 40. While shown in the context of a drinking vessel 40, the mount 10 of the present invention may be utilized to secure a mobile electronic device 38 to several supporting structures. By way of example, the mount 10 may secure to structural members of fitness equipment at a gymnasium. In some embodiments, the longitudinal length of the elongate sleeve may be varied to accommodate various sized supporting structures, such as handlebars for a bicycle or motorcycle. In other embodiments, the longitudinal length of the elongate sleeve may be extended to accommodate larger supporting structural members, such as a utility pole or a pipe.

In the preferred embodiment, where the mount 10 is dimensioned for attachment to a drinking vessel 40, the mount 10 provides a convenient hands-free means of supporting the mobile electronic device 38 for use while operating a motor vehicle. With the mobile electronic device 38 attached to the drinking vessel 40, the user may simply place the drinking vessel 40 in a cup holder of the motor vehicle. The user may then adjust the positioning of a display screen of the mobile electronic device 38 by movement of the device 38 about the ball mount 32 and the socket 34.

It should be understood, of course, that the foregoing relates to exemplary embodiments of the invention and that modifications may be made without departing from the spirit and scope of the invention as set forth in the following claims.

What is claimed is:

1. A mount for a mobile electronic device, comprising:
an elongate elastic sleeve having a first end, a second end and an intermediate portion disposed between the first end and the second end;
a fastener attached proximal to the second end of the elongate elastic sleeve;
a cooperating fastener attached to the intermediate portion proximal to the fastener;
a slot defined transversely and extending through the elongate elastic sleeve, the slot dimensioned to receive the fastener and at least a portion of the elongate elastic sleeve between the fastener and the cooperating fastener;
a ball mount attached to the intermediate portion between the cooperating fastener and the slot; and
a socket coupled to the ball mount, the socket formed of one of a magnetically attractive or a magnetic material.

2. The mount of claim 1, further comprising:
a device plate formed of one of a material complimentary to the one of the magnetically attractive or the magnetic material of the socket.

3. The mount of claim 2, further comprising:
an adhesive layer on a device facing surface of the device plate.

4. The mount of claim 1, wherein the elongate elastic sleeve comprises:
a plurality of fabric layers.

5. The mount of claim 4, wherein the plurality of fabric layers comprises:
a surface laminate layer;
a lining laminate layer; and
a core layer disposed between the surface laminate layer and the lining laminate layer.

6. The mount of claim 1, further comprising:
a backing plate attached to a front surface of the elongate elastic sleeve; and
a backing plate fastener coupling the ball mount to the backing plate.

7. The mount of claim 6, further comprising:
a pocket dimensioned to surround the backing plate and attach the backing plate to the front surface of the elongate elastic sleeve.

8. The mount of claim 1, wherein the fastener and the cooperating fastener are formed of a hook and a loop material.

9. The mount of claim 1, further comprising:
a reinforcement defined about the slot.

10. The mount of claim 9, wherein the reinforcement is a stitch.

11. The mount of claim 9, wherein the reinforcement is a solid or a semi-solid grommet.
